(19) United States
(12) Patent Application Publication
(10) Pub. No.: US 2012/0117187 A1
(43) Pub. Date: May 10, 2012

(54) INTERACTIVE ELECTRONIC SYSTEM

(75) Inventors: Zhou Ye, Foster City, CA (US); Pei-Chuan Liu, Taipei City (TW)

(73) Assignee: BLUESPACE CORPORATION, APIA (WS)

(21) Appl. No.: 13/282,444

(22) Filed: Oct. 26, 2011

Related U.S. Application Data
(60) Provisional application No. 61/410,371, filed on Nov. 5, 2010.

(30) Foreign Application Priority Data
Sep. 5, 2011 (CN) 201120341170.8

(51) Int. Cl. H04W 8/22; G06F 15/16

(52) U.S. Cl. 709/217

(57) ABSTRACT

The present invention provides an interactive electronic system and an operation method for an interactive electronic system, wherein the interactive electronic system comprises: a first electronic device and a second electronic device. When the interactive electronic system is a portable electronic device (such as a notebook or a tablet PC), the first electronic device and the second electronic device can be a host and a wireless displayer, respectively. Since the host and the wireless displayer can be separated when the user uses the interactive electronic system, the interactive electronic system can efficiently reduce the weight loading for the user, and provide more freedom and better convenience for the user when using it. In addition, the user also can connect and combine the host and the wireless displayer to be a single device when it is necessary.

### CROSS REFERENCE TO RELATED APPLICATIONS

This application claims the benefit of U.S. Provisional Application No. 61/410,371, filed on Nov. 5, 2010 and included herein by reference.

### BACKGROUND OF THE INVENTION

1. Field of the Invention

The present invention relates to an interactive electronic system and an operation method for the interactive electronic system, and more particularly, to an interactive electronic system having a portable display device and an operation method for the interactive electronic system having a portable display device.

2. Description of the Prior Art

In general, in the conventional notebook and tablet PC, the displayer and the host are connected to each other with various wires, and a user can not separate the host and the displayer. Thus, the conventional notebook and tablet PC can not efficiently reduce the weight loading for the user, and can not provide more freedom and better convenience for the user when using it, either.

In addition, in the conventional PC and smart TV, although the host and the displayer are separated, the displayer and the host in the conventional PC and smart TV are also connected to each other with various wires. Thus, there will be many wires in the user's working environment and/or living environment, and it makes the user's working environment and/or living environment become a mess and not easy to clean and arrange for the user.

### SUMMARY OF THE INVENTION

It is therefore one of the objectives of the present invention to provide an interactive electronic system having a portable display device and an operation method for the interactive electronic system, so as to solve the above problem.

In accordance with an embodiment of the present invention, an interactive electronic system is disclosed. The interactive electronic system comprises a first electronic device and a second electronic device. The first electronic device comprises a signal processing unit, for generating a data flow according to a connecting mode information and a control information; and a first wireless communication unit, coupled to the signal processing unit, for transmitting the data flow and the control information. The second electronic device comprises: a second wireless communication unit, for receiving the data flow from the first electronic device; an image processing unit, coupled to the second wireless communication unit, for processing the data flow to generate at least an image signal; and a display unit, coupled to the image processing unit, for displaying the image signal.

In accordance with an embodiment of the present invention, an operation method for an interactive electronic system is disclosed, wherein the interactive electronic system comprises a first electronic device and a second electronic device, and the operation method comprises: generating a data flow according to a connecting mode information and a control information; transmitting the data flow from the first electronic device to the second electronic according to the connecting mode information; generating at least an image signal by processing the data flow; and displaying the image signal in the second electronic device.

In accordance with an embodiment of the present invention, an interactive electronic system is disclosed. The interactive electronic system comprises: a host, for generating a plurality of sound signals and a plurality of image signals according to a connecting mode information and a control information, and transmitting the sound signals and the image signals via a first wireless communication unit; and a portable display device, for receiving the control information via a user interface and transmitting the control information to the host, and receiving the sound signals and the image signals to display corresponding sounds and images via a second wireless communication unit.

Briefly summarized, in the disclosure of the present invention, when the interactive electronic system is a portable electronic device (such as a notebook or a tablet PC), since the host and the wireless displayer can be separated when the user uses the interactive electronic system, the interactive electronic system can efficiently reduce the weight loading for the user, and provide more freedom and better convenience for the user when using it. When the interactive electronic system is a fixed electronic device (such as a PC, or a smart TV), since there is no wires required between the host and the wireless displayer, the interactive electronic system can make the user's working environment and/or living environment cleaner, simpler, and easier to clean and arrange for the user. In addition, the user also can connect and combine the host and the wireless displayer to be a single device when it is necessary.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified diagram of an interactive electronic system in accordance with an embodiment of the present invention

FIG. 2 shows a simplified block diagram of a interactive electronic system in FIG. 1.

FIG. 3A shows another simplified block diagram of a interactive electronic system in FIG. 1.

FIG. 3B shows another simplified block diagram of a interactive electronic system in FIG. 1.

FIG. 4 shows another simplified block diagram of the interactive electronic system in FIG. 1.

FIG. 5 shows another simplified block diagram of a interactive electronic system in FIG. 1.

FIG. 6 is a flowchart showing an operation method for an interactive electronic system in accordance with the operation schemes of the interactive electronic system in a first embodiment of the present invention.

FIG. 7 is a flowchart showing an operation method for an interactive electronic system in accordance with the operation schemes of the interactive electronic system in a second embodiment of the present invention.

### DETAILED DESCRIPTION

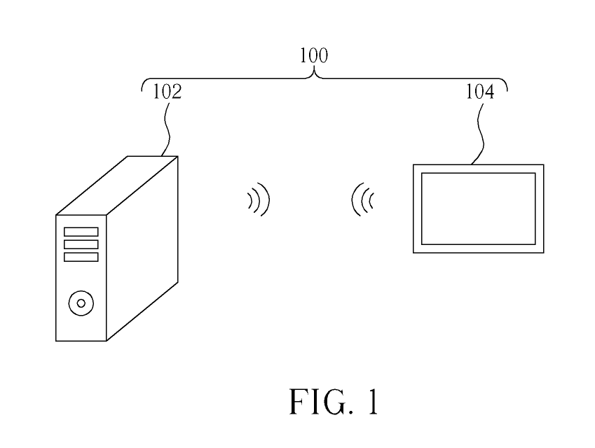

Please refer to FIG. 1. FIG. 1 shows a simplified diagram of an interactive electronic system 100 in accordance with an embodiment of the present invention, wherein the interactive electronic system 100 can be a portable electronic device (such as a notebook, a tablet PC, or a smart phone, etc.). As shown in FIG. 1, the interactive electronic system 100 comprises: a first electronic device 102 and a second electronic device 104. The first electronic device 102 is wirelessly connected to the second electronic device 104. The second electronic device 104 can be a wireless touch panel screen having a small size (such as 7 inches, 11 inches, or 15 inches, etc.), and the first electronic device 102 can be a computer having a corresponding size.

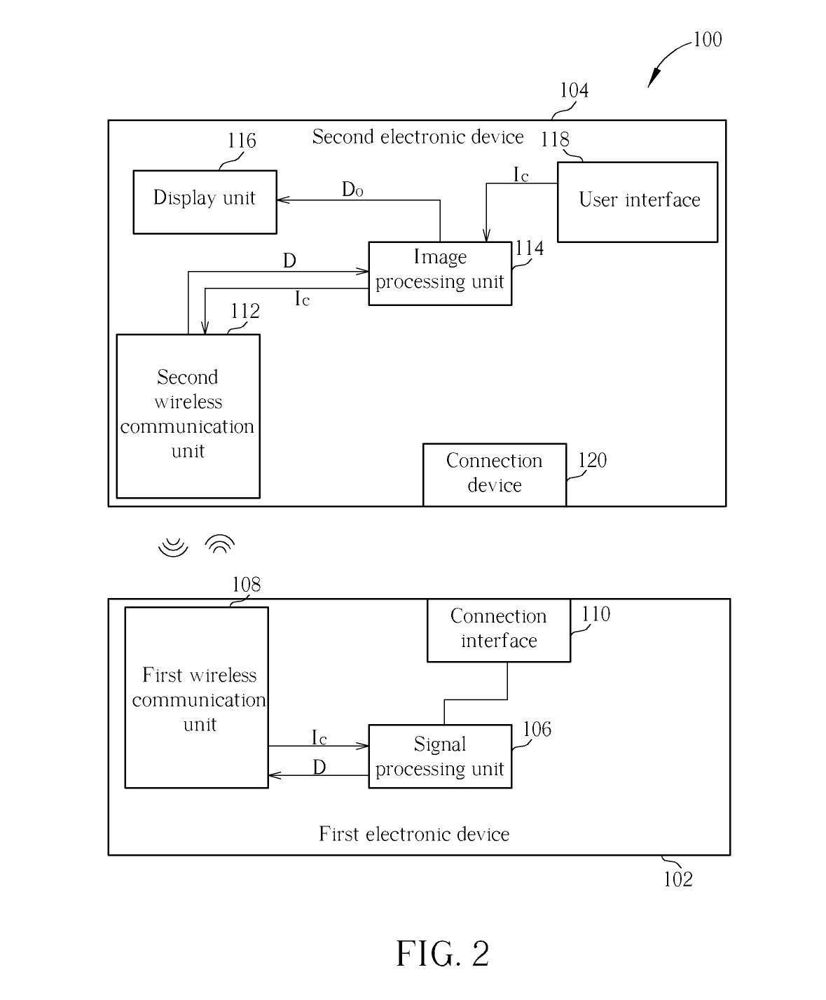

Please refer to FIG. 2. FIG. 2 shows a simplified block diagram of a interactive electronic system 100 in FIG. 1. As shown in FIG. 2, the first electronic device 102 comprises: a signal processing unit 106, a first wireless communication unit 108, and a connection interface 110. The second electronic device 104 comprises: a second wireless communication unit 112, an image processing unit 114, a displaydisplay unit 116, a user interface 118, and a connection device 120. In this embodiment, when the signal processing unit 106 detects that the connection interface 110 of the first electronic device 102 is not connected to the connection device 120 of the second electronic device 104, the signal processing unit 106 will turn on the first wireless communication unit 108 and the second wireless communication unit 112.

In this embodiment, the user interface 118 is utilized for receiving the control information I_{C}, and transmitting the control information I_{C} to the second wireless communication unit 112 via the image processing unit 114. The second wireless communication unit 112 modulates the control information I_{C} and transmits the modulated control information I_{C} to the first wireless communication unit 108 of the first electronic device 102 via an antenna (not shown). The first wireless communication unit 108 demodulates the modulated control information I_{C} to become the control information I_{C} and transmits it to the signal processing unit 106, and the signal processing unit 106 performs a signal processing process to generate a data flow D according to the control information I_{C}. The signal processing unit 106 transmits the data flow D to the second electronic device 104 via the first wireless communication unit 108, and the second electronic device 104 use the second wireless communication unit 112 to receive the data flow D. The image processing unit 114 is coupled to the second wireless communication unit 112, and utilized for generating an image signal D_{O} according to the received data flow D. The displaydisplay unit 116 is coupled to the image processing unit 114, and utilized for displaying the image signal D_{O}.

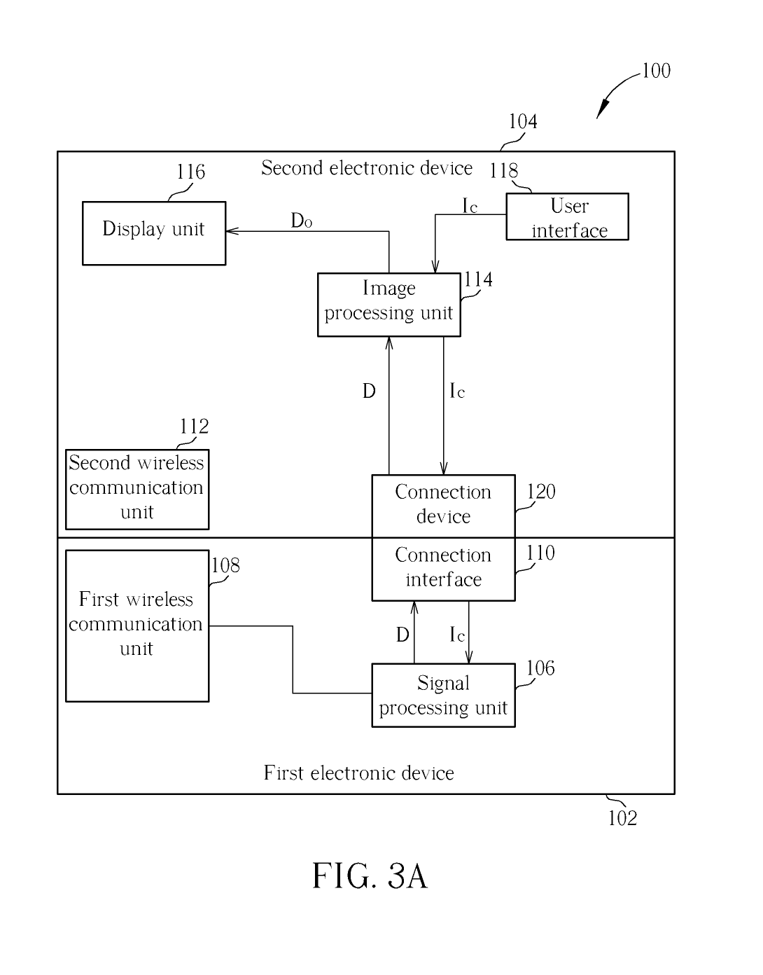

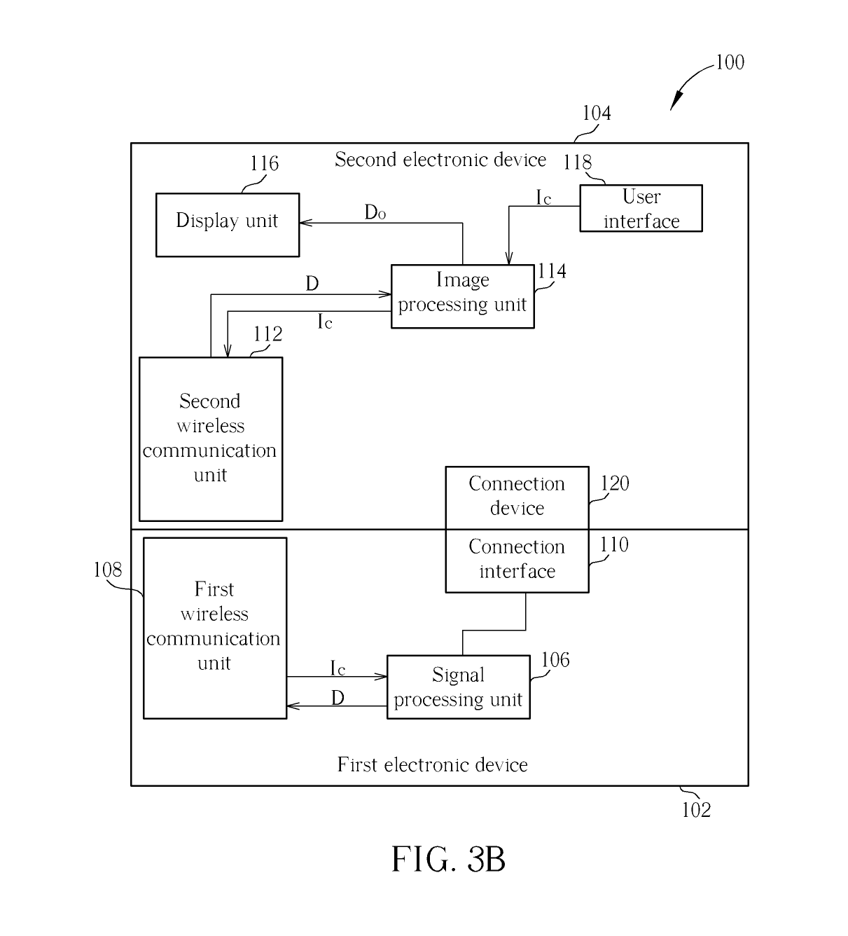

Please note that the above embodiment is only for an illustrative purpose and is not meant to be a limitation of the present invention. For example, the second electronic device 104 can be optionally electrically connected to the connection interface 110 of the first electronic device 102 via the connection device 120, as shown in FIG. 3A. In addition, in the embodiment shown in FIG. 3A, when the signal processing unit 106 detects that the connection interface 110 of the first electronic device 102 is connected to the connection device 120 of the second electronic device 104 and the user turns off the first wireless communication unit 108 and the second wireless communication unit 112 by inputting other control information via the user interface 118, the control information I_{C} and the data flow D will be transmitted between the first electronic device 102 and the second electronic device 104 via the connection interface 110 and the connection device 120. Since the first wireless communication unit 108 and the second wireless communication unit 112 are turned off, the power consumption of the first electronic device 102 and the second electronic device 104 can be saved.

In addition, the first wireless communication unit 108 and the second wireless communication unit 112 also can be turned off by other methods. For example, when the signal processing unit 106 detects that the connection interface 110 of the first electronic device 102 is connected to the connection device 120 of the second electronic device 104, the first wireless communication unit 108 is turned off first, and when the second wireless communication unit 112 does not receive the data stream transmitted from the first wireless communication unit 108, the second wireless communication unit 112 will be turned off by itself. In the meantime, the control information I_{C} and the data flow D will be transmitted between the first electronic device 102 and the second electronic device 104 via the connection interface 110 and the connection device 120.

Moreover, as shown in FIG. 3B, when the signal processing unit 106 detects that the connection interface 110 of the first electronic device 102 is connected to the connection device 120 of the second electronic device 104, the user also can choose to not to turn off the first wireless communication unit 108 and the second wireless communication unit 112. That is, the control information I_{C} and the data flow D are still transmitted via the first wireless communication unit 108 and the second wireless communication unit 112.

In another embodiment, when the interactive electronic system 100 is a fixed electronic device (such as a PC, or a smart TV, etc.), the second electronic device 104 can be a wireless panel screen having a big size (such as 22 inches, 24 inches, 23 inches, or 40 inches, etc.), and the first electronic device 102 can be a computer having an arbitrary size. The user can control the wireless panel screen via a wireless keyboard, a wireless mouse, and/or a remote controller to use the fixed electronic device. The wireless panel screen can wirelessly transmit the control information I_{C} to the computer to control the computer.

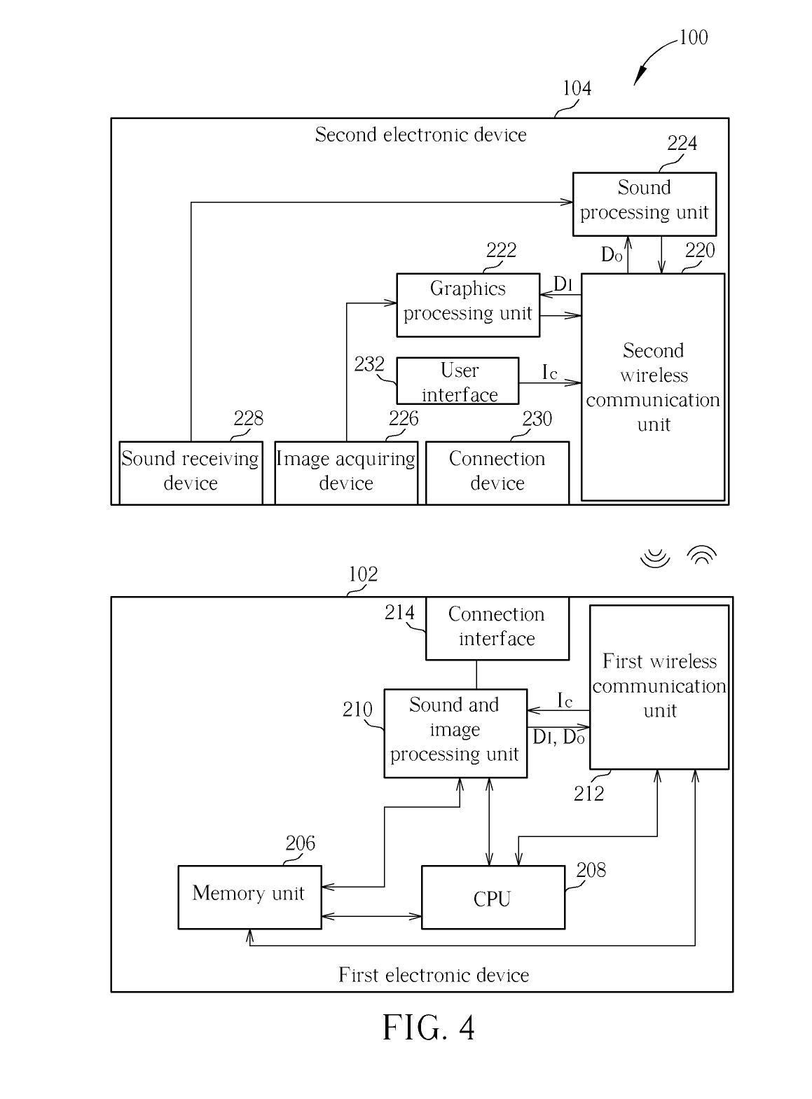

Next, please refer to FIG. 4. FIG. 4 shows another simplified block diagram of the interactive electronic system 100 in FIG. 1. In this embodiment, the first electronic device 102 can be a computer, and the second electronic device 104 can be a portable display device (such as a wireless touch panel screen). As shown in FIG. 4, the second electronic device 104 comprises: a second wireless communication unit 220, a graphics processing unit 222, a sound processing unit 224, an image acquiring device 226, a sound receiving device 228, a connection device 230, and a user interface 232. Since there is no CPU and memory in the second electronic device 104, the second electronic device 104 can reduce required power consumption when used by the user, so as to save power. The first electronic device 102 comprises: a memory unit 206, a CPU 208, a sound and image processing unit 210, a first wireless communication unit 212, and a connection interface 214. The CPU 208 is coupled to the memory unit 206, and utilized for executing an operation system.

In this embodiment, when the CPU 208 detects that the connection interface 214 of the first electronic device 102 is not connected to the connection device 230 of the second electronic device 104, the CPU 208 will turn on the first wireless communication unit 212 and the second wireless communication unit 220. The user interface 232 is utilized for receiving the control information I_{C} inputted by the user, and the second wireless communication unit 220 is utilized for transmitting the control information I_{C} to the first electronic device 102 via the first wireless communication unit 212.

The sound and image processing unit 210 is coupled to the memory unit 206 and the CPU 208, and utilized for performing a signal processing process to generate a plurality of sound signals D_{I} and a plurality of image signals D_{I} according to the control information I_{C} inputted by the user, wherein the sound signals D_{O} and the image signals D_{I} can be compressed signals or uncompressed signals. The first wireless communication unit 212 is coupled to the sound and image processing unit 210, the memory unit 206, and the CPU 208, and utilized for transmitting the sound signals D_{O} and the image signals D_{I}.

The second wireless communication unit 220 and the first wireless communication unit 212 can be RF units. The connection interface 214 is coupled to the sound and image processing unit 210, the memory unit 206, and the CPU 208. Please note that the above embodiment is only for an illustrative purpose and is not meant to be a limitation of the present invention. For example, the first electronic device 102 can further comprises various peripheral devices such as a power supply (not shown), a battery (not shown), a hard drive (not shown), and/or an optical drive (not shown), etc. In addition, the first electronic device 102 can be electrically connected to an external power source (not shown) via a power wire.

The second electronic device 104 uses the second wireless communication unit 220 to receive the sound signals D_{O} and the image signals D_{I}. The received the sound signals D_{O} is transmitted to the graphics processing unit 222, and the image signals D_{I} is transmitted to the sound processing unit 224. The graphics processing unit 222 is utilized for processing the image signals D_{I}, wherein the graphics processing unit 222 can be a graphics card. The sound processing unit 224 is utilized for processing the sound signals D_{O}, wherein the sound processing unit 224 and can be a sound card.

The image acquiring device 226 is coupled to the graphics card, and utilized for acquiring a plurality of images. The second wireless communication unit 220 transmits the images acquired by the image acquiring device 226 to the first electronic device 102, wherein the image acquiring device 226 can be a camera. The sound receiving device 228 is coupled to the sound processing unit 224, and utilized for receiving a plurality of sounds. The second wireless communication unit 220 transmits the images acquired by the image acquiring device 226 to the first electronic device 102, wherein the sound processing unit 224 can be a microphone.

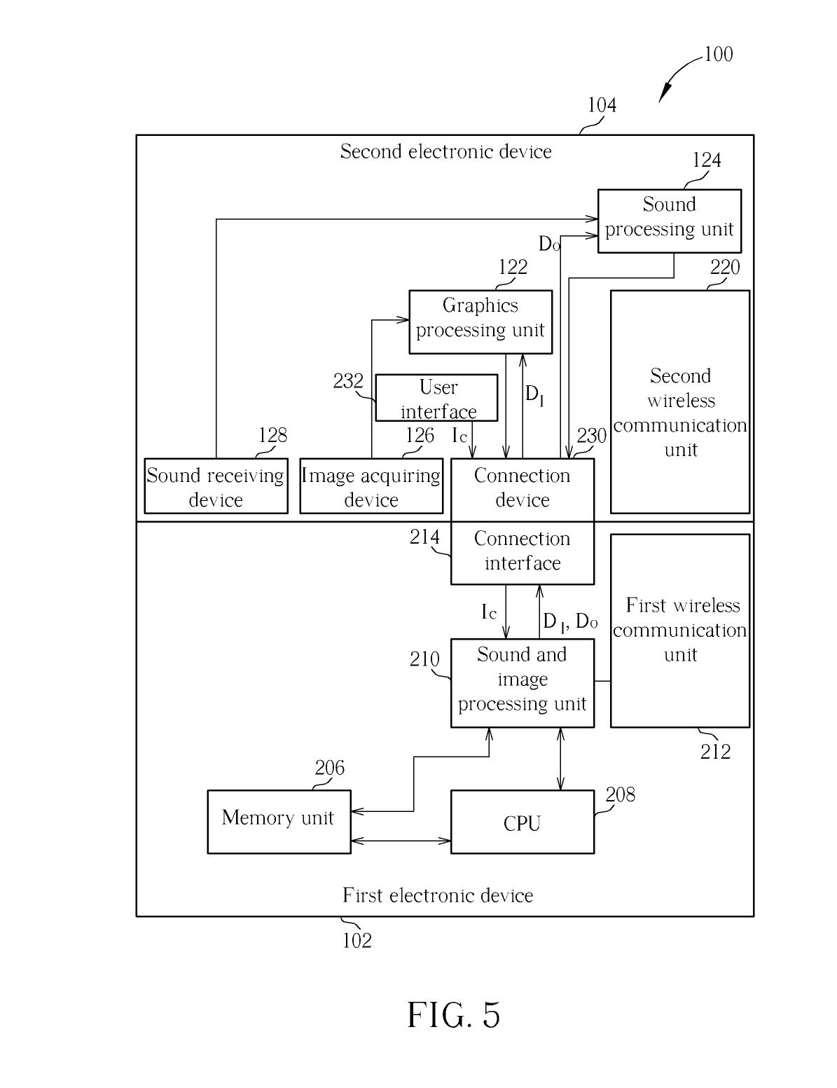

Please note that the above embodiment is only for an illustrative purpose and is not meant to be a limitation of the present invention. For example, the second electronic device 104 can be optionally electrically connected to the connection interface 214 of the first electronic device 102 via the connection device 230, as shown in FIG. 5. In addition, in the embodiment shown in FIG. 5, when the connection interface 214 of the first electronic device 102 is electrically connected to the connection device 230 of the second electronic device 104, the control information I_{C} and the data flow D will be transmitted between the first electronic device 102 and the second electronic device 104 via the connection interface 214 and the connection device 230. Thus, the user can turn off the first wireless communication unit 212 and the second wireless communication unit 220, to save power for the first electronic device 102 and the second electronic device 104.

Please note that the above embodiment is only for an illustrative purpose and is not meant to be a limitation of the present invention. For example, the sound processing unit 224, the image acquiring device 226, and the sound receiving device 228 of the second electronic device 104 can be omitted according to different design requirements in other embodiments of the present invention.

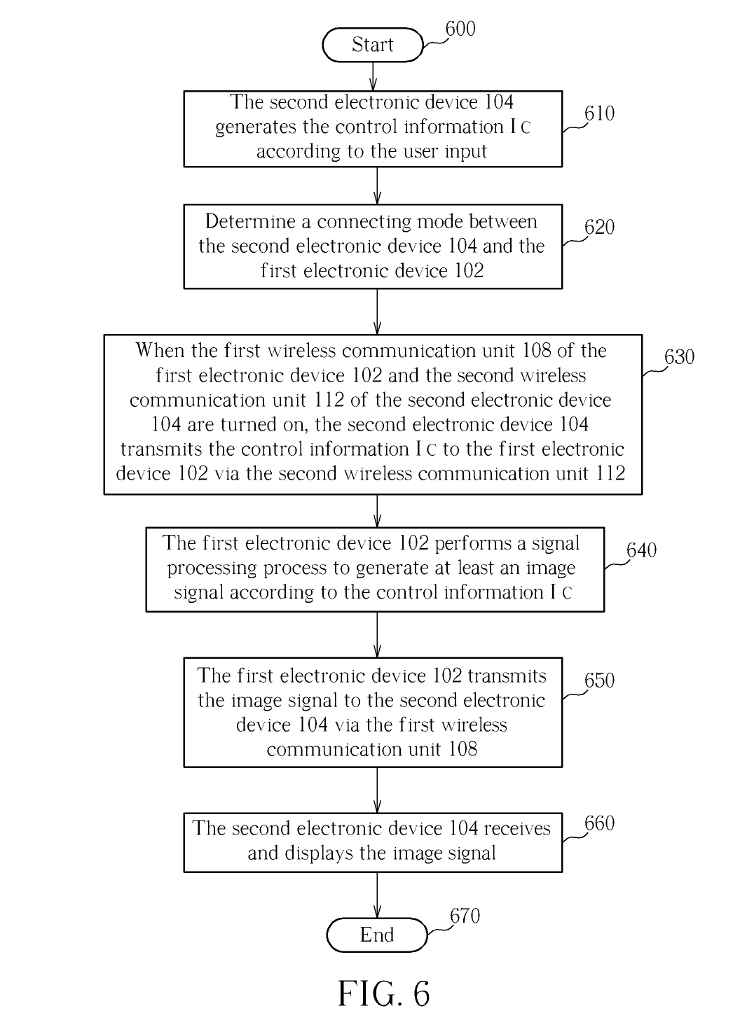

Please refer to FIG. 6. FIG. 6 is a flowchart showing an operation method for an interactive electronic system in accordance with the above operation schemes of the interactive electronic system 100 in a first embodiment of the present invention. Provided that substantially the same result is achieved, the steps of the process flowchart need not be in the exact order shown in FIG. 6 and need not be contiguous, that is, other steps can be intermediate. The operation method in accordance with the first embodiment of the present invention comprises the following steps:

Step 600: Start.

Step 610: The second electronic device 104 generates the control information I_{C} according to the user input.

Step 620: Determine a connecting mode between the second electronic device 104 and the first electronic device 102.

Step 630: When the first wireless communication unit 108 of the first electronic device 102 and the second wireless communication unit 112 of the second electronic device 104 are turned on, the second electronic device 104 transmits the control information I_{C} to the first electronic device 102 via the second wireless communication unit 112.

Step 640: The first electronic device 102 performs a signal processing process to generate at least an image signal according to the control information I_{C}.

Step 650: The first electronic device 102 transmits the image signal to the second electronic device 104 via the first wireless communication unit 108.

Step 660: The second electronic device 104 receives and displays the image signal.

Step 670: End.

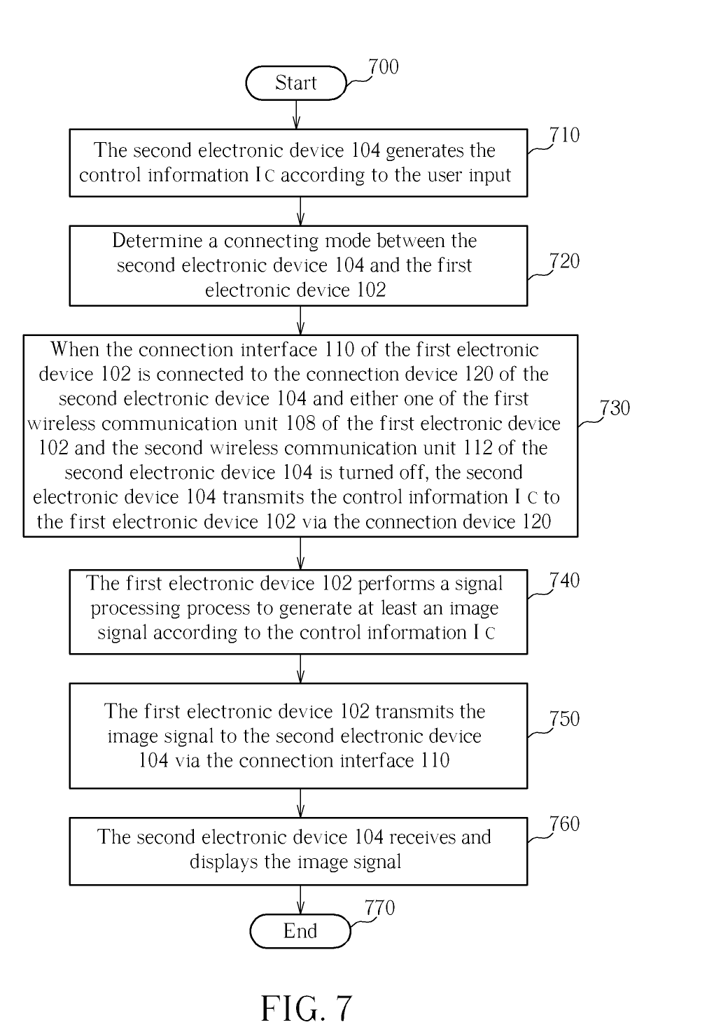

Please refer to FIG. 7. FIG. 7 is a flowchart showing an operation method for an interactive electronic system in accordance with the above operation schemes of the interactive electronic system 100 in a second embodiment of the present invention. Provided that substantially the same result is achieved, the steps of the process flowchart need not be in the exact order shown in FIG. 7 and need not be contiguous, that is, other steps can be intermediate. The operation method in accordance with the second embodiment of the present invention comprises the following steps:

Step 700: Start.

Step 710: The second electronic device 104 generates the control information I_{C} according to the user input.

Step 720: Determine a connecting mode between the second electronic device 104 and the first electronic device 102.

Step 730: When the connection interface 110 of the first electronic device 102 is connected to the connection device 120 of the second electronic device 104 and either one of the first wireless communication unit 108 of the first electronic device 102 and the second wireless communication unit 112 of the second electronic device 104 is turned off, the second electronic device 104 transmits the control information I_{C} to the first electronic device 102 via the connection device 120.

Step 740: The first electronic device 102 performs a signal processing process to generate at least an image signal according to the control information I_{C}.

Step 750: The first electronic device 102 transmits the image signal to the second electronic device 104 via the connection interface 110.

Step 760: The second electronic device 104 receives and displays the image signal.

Step 770: End.

Briefly summarized, in the disclosure of the present invention, when the interactive electronic system is a portable electronic device (such as a notebook or a tablet PC), since the host and the wireless displayer can be separated when the user uses the interactive electronic system, the interactive electronic system can efficiently reduce the weight loading for the user, and provide more freedom and better convenience for the user when using it. When the interactive electronic system is a fixed electronic device (such as a PC, or a smart TV), since there is no wires required between the host and the wireless displayer, the interactive electronic system can make the user's working environment and/or living environment cleaner, simpler, and easier to clean and arrange for the user. In addition, the user also can connect and combine the host and the wireless displayer to be a single device when it is necessary.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interactive electronic system, comprising:
a first electronic device, comprising:
a signal processing unit, for generating a data flow according to a connecting mode information and a control information; and
a first wireless communication unit, coupled to the signal processing unit, for transmitting the data flow and the control information; and
a second electronic device, comprising:
a second wireless communication unit, for receiving the data flow from the first electronic device;
an image processing unit, coupled to the second wireless communication unit, for processing the data flow to generate at least an image signal; and
a display unit, coupled to the image processing unit, for displaying the image signal.

2. The interactive electronic system of claim 1, wherein the second electronic device further comprises an image acquiring device, coupled to the signal processing unit, for acquiring at least an image, and the second wireless communication unit transmits the image acquired by the image acquiring device to the first electronic device.

3. The interactive electronic system of claim 1, wherein the second electronic device further comprises a user interface for receiving the control information, and the control information is transmitted to the first electronic device via the second wireless communication unit to control the data flow.

4. The interactive electronic system of claim 1, wherein the second electronic device further comprises a connection device, the first electronic device further comprises a connection interface, and the connecting mode information is determined by whether the connection device electrically connecting the connection interface and a switch state of the first wireless communication unit and the second wireless communication unit.

5. The operation method of claim 4, wherein the data flow is transmitted from the connection interface to the connection device when the connection interface is connected to the connection device and either one of the first wireless communication unit and the second wireless communication unit is turned off.

6. An operation method for an interactive electronic system comprising a first electronic device and a second electronic device, the operation method comprising:
generating a data flow according to a connecting mode information and a control information;
transmitting the data flow from the first electronic device to the second electronic according to the connecting mode information;
generating at least an image signal by processing the data flow; and
displaying the image signal displayin the second electronic device.

7. The operation method of claim 6, further comprises:
acquiring at least an image by the second electronic device; and
transmitting the image from the second electronic device to the first electronic device.

8. The operation method of claim 6, further comprises:
receiving the control information from a user interface in the second electronic device ; and
transmitting the control information from the second electronic device to the first electronic device to control the data flow.

9. The operation method of claim 6, further comprises:
providing a connecting device and a second wireless communication unit in the second electronic device, and a connection interface and a first wireless communication unit in the first electronic device; and
generating the connecting mode information by determining whether the connection device electrically connecting the connection interface and a switch state of the first wireless communication unit and the second wireless communication unit.

10. The operation method of claim 9, wherein the transmitting step further comprises: transmitting the data flow from the first wireless communication unit to the second wireless communication unit when the first wireless communication unit and the second wireless communication unit are turned on.

11. The operation method of claim 9, wherein the transmitting step further comprises: transmitting the data flow from the connection interface to the connection device when the connection interface is connected to the connection device and either one of the first wireless communication unit and the second wireless communication unit is turned off.

12. The operation method of claim 6, wherein the displaying step further comprises:
providing a displaying unit in the second electronic device; and
displaying the image signal in the displaying unit.

13. An interactive electronic system, comprising:
a host, for generating a plurality of sound signals and a plurality of image signals according to a connecting mode information and a control information, and transmitting the sound signals and the image signals via a first wireless communication unit; and
a portable display device, for receiving the control information via a user interface and transmitting the control information to the host, and receiving the sound signals and the image signals to display corresponding sounds and images via a second wireless communication unit.

14. The interactive electronic system of claim 13, wherein the host transmits the sound signals and the image signals via the first wireless communication unit when the first wireless communication unit and the second wireless communication unit are turned on.

15. The interactive electronic system of claim 13, wherein the host comprises:
a memory unit;
a CPU, coupled to the memory unit, for executing an operation system, and generating the connecting mode information according to a connecting mode of the host and the portable display device and a switch state of the first wireless communication unit and the second wireless communication unit; and
a sound and image processing unit, coupled to the memory unit and the CPU, for generating the sound signals and the image signals according to the control information.

16. The interactive electronic system of claim 13, wherein the portable display device comprises:
a graphics card for receiving the image signals from the second wireless communication unit and processing the image signals; and
a sound card for receiving the sound signals from the second wireless communication unit and processing the sound signals.

17. The interactive electronic system of claim 16, wherein the portable display device further comprises:
a camera, coupled to the graphics card, for acquiring at least an image; and
a microphone, coupled to the sound card, for receiving at least a sound;
wherein the second wireless communication unit transmits the image acquired by the camera and the sound received by the microphone to the host.

18. The interactive electronic system of claim 13, wherein the portable display device further comprises a connection device, the host further comprises a connection interface, the host generates the connecting mode information by determining whether the connection device of the portable display device electrically connecting the connection interface of the host, and the host transmits the sound signals and the image signals from the connection interface to the connection device when the connection interface is connected to the connection device.

19. The interactive electronic system of claim 13, wherein the portable display device further comprises: a user interface for receiving the control information; and the control information is transmitted to the first electronic device via the second wireless communication unit to control the sound signals and the image signals.

20. The interactive electronic system of claim 13, wherein the portable display device is a wireless touch panel screen.
